(19) United States
(12) Patent Application Publication
(10) Pub. No.: US 2009/0115727 A1
(43) Pub. Date: May 7, 2009

(54) Input Device with Physiological Measuring Function

(75) Inventor: Tung-Ke WU, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTek Computer Inc., Taipei (TW)

(21) Appl. No.: 12/247,395

(22) Filed: Oct. 8, 2008

(30) Foreign Application Priority Data
Nov. 6, 2007 (TW) 096141864

(51) Int. Cl. G06F 3/033

(52) U.S. Cl. 345/163

(57) ABSTRACT

An input device with the physiological measuring function includes a housing, a circuit board, a sensor module and a light guiding element. The housing has a transparent handheld part. The circuit board is disposed in the housing. The sensor module is electrically connected with the circuit board. The light guiding element is located between the sensor module and the transparent handheld part. The input device with the physiological measuring function of the invention has better holding feelings, and the configuration of the light guiding element overcomes the measuring differences between users, so that the reliability of the measuring result is thus ensured.

### CROSS REFERENCE TO RELATED APPLICATIONS

This Non-provisional application claims priority under 35 U.S.C. §119(a) on Patent Application No(s). 096141864 filed in Taiwan, Republic of China on Nov. 6, 2007, the entire contents of which are hereby incorporated by reference.

### BACKGROUND OF THE INVENTION

1. Field of Invention

The invention relates to an input device; more particularly, to an input device with a physiological measuring function.

2. Related Art

Accompanying the progressive of technology, the computer has become one of the indispensable devices in our lives. Taking the medical treatment as an example, the physiological signals of the patient must be continuously monitored by the equipment of the health center for measuring and showing the results on a monitor. When the shown physiological signals are abnormal, the professional medical members will perform proper medical actions according to the results shown on the monitor. This medical treatment, however, needs a great number of medical professionals and is rather expensive. Furthermore, it is difficult to apply this medical treatment to the patients in remote districts. For example, the present medical services including the sphygmomanometer, ear thermometer, and blood glucose meter, are developed from the traditional hospital or clinic therapy to the in-home therapy. Moreover, the sphygmomanometer, ear thermometer, and blood glucose meter can cooperate with the computer, video conference, and the Internet to carry out the long-distance medical treatment.

As shown in FIG. 1, a conventional input device 10 with the physiological measuring function (e.g. a heartbeat measuring function) includes a housing 11 and a sensor module 13. The housing 11 has a handheld part 111, and the sensor module 13 is fixed at a specific position on the handheld part 111. When the user uses the input device 10 to measure the heartbeat, he must continuously press the sensor module 13. Consequently, the soreness and discomfort to the user's hand may be caused. In addition, the dirt and hand sweat may be remained on the surface of the sensor module 13 hence affect the measuring result.

Additionally, since the sensor module 13 on the input device 10 is fixed at a position that cannot be adjusted, this may cause misfit in handheld position to the users in different genders and ages; hence affect and lead to a low reliability of the measuring result.

The utility of the input device with the measuring functions is usually improved by increasing the amount of the sensor modules so as to extend the measuring area. This method, however, also increases the cost of the input device. Other than the sufficient measuring area, the input device has to fit the using habits of the users as well. Thus the input device must provide better handheld feeling and prevent the dirt from being remained thereon, which may affect the accuracy of the measuring results.

### SUMMARY OF THE INVENTION

An object of the invention is to provide an input device with physiological measuring function, with such device the measuring area may be extended through the light guiding element adjusted to different physiological conditions and user habits. Meanwhile, the users do not have a direct contact to the sensor module while measuring; this could prevent the hand sweat and the dirt from remaining on the sensor module surface and affecting the measuring result.

An input device with physiological measuring function of the invention includes a housing, a circuit board, a sensor module, and a light guiding element. The housing has a transparent handheld part. The circuit board is disposed in the housing. The sensor module is electrically connected with the circuit board. The light guiding element is located between the sensor module and the transparent handheld part.

The physiological signals as described herein are heartbeat, pulse, sweat exhaust, skin temperature, blood signal, oxygen concentration of blood, muscle tension, or blood pressure, but not limited to these.

As mentioned above, a more preferred operation may be provided with the physiological measuring processed by transmitting the light signal through the transparent handheld part, and, therefore, the sensor module does not have to directly contact with the users so as to keep the module surface clean. Furthermore, the measuring area may be extended through the light guiding element. Compare with the prior art, the input device of the invention is able to overcome the differences between the habits of individuals hence ensure the reliability of the measuring result.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a conventional input device with the physiological measuring function;

FIG. 2A is a partial sectional diagram of an input device according to a first embodiment of the invention;

FIG. 2B is a schematic diagram showing the sensor module transmitting the light through the light guiding element according to the first embodiment of the invention;

FIGS. 3A and 3B are schematic diagrams showing different measuring aspects;

FIG. 4 is a schematic diagram of the processing of the signal between the sensor module and the electronic component according to the preferred embodiment of the invention;

FIG. 5A is a partial sectional diagram of the input device according to a second embodiment of the invention;

FIG. 5B is a schematic diagram showing the sensor module transmitting the light through the solid light guiding element according to the second embodiment of the invention;

FIG. 5C is a schematic diagram showing the sensor module transmitting the light through the light guiding element and dot structure rod according to the second embodiment of the invention;

FIG. 6A is a partial sectional diagram of the input device according to a third embodiment of the invention; and

FIG. 6B is a schematic diagram showing the sensor module transmitting the light through the optical fiber according to the third embodiment of the invention.

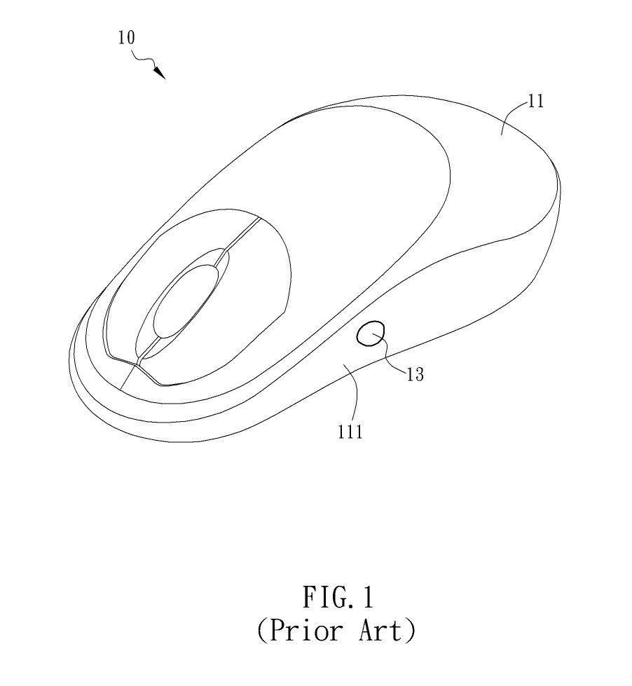

### DETAILED DESCRIPTION OF THE INVENTION

The present invention will be apparent from the following detailed description, which proceeds with reference to the accompanying drawings, wherein the same references relate to the same elements.

In the following illustrations, the sensor module of the input device measures the photo plethysmographic (PPG). The PPG calculates the continuous waveform variation of the blood volume inside the blood vessels according to the light refractiveness and refraction angles. It can be found that the blood volume, pulse, and blood pressure in the blood circulation system are closely linked. Thus, the sensor module of the input device with the physiological measuring function in the following embodiment is a photo plethysmographic (PPG) sensor module.

### First Embodiment

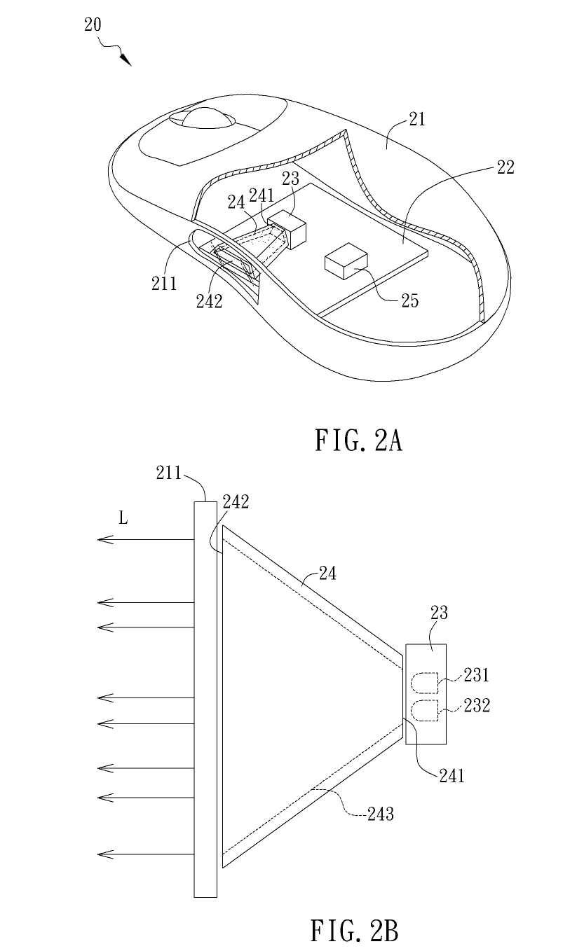

With reference to FIGS. 2A and 2B, the input device 20 with physiological measuring function includes a housing 21, a circuit board 22, a sensor module 23, and a light guiding element 24. In the embodiment, the housing 21 has a transparent handheld part 211, and the sensor module 23 is disposed on and electrically connected with the circuit board 22, which is disposed in the housing 21. Additionally, the light guiding element 24 is located between the sensor module 23 and transparent handheld part 211. The sensor module 23 and transparent handheld part 211 are mentioned herein as examples and are not to limit the scope of the invention.

The sensor module 23 includes at least one light guiding element 231 and a sensor element 232. In the embodiment, the light guiding element 231 may be a light emitting diode (LED) or an organic light emitting diode (OLED), and the sensor element 232 may be a photo diode (PD), charge coupling device (CCD), or a complementary metal oxide semiconductor (CMOS).

The sensor module 23 transmits signals to an electronic component 25 electrically connected to the circuit board 22. Such electronic component 25 may be the wireless module such as radio frequency (RF) or Bluetooth (not shown), but not limited to these. The power supply of the sensor module 23 may be a battery or from a computer (not shown).

In the embodiment, the light guiding element 24 is a tube structure with a narrow bottom and a wide top, but not limited to it. One end of the light guiding element 24 is adjusted to the aspect of the sensor module 23 to form a narrow opening 241; the other end thereof is adjusted to a wide opening 242. The descriptions above are used for example and are not to limit the scope of the invention.

The sensor module 23 transmits the light L in a space formed by the light guiding element 24. A reflecting film 243 is coated on the exterior of the light guiding element 24, so that the light L can travel through the light guiding element 24 with being reflected by the reflecting film 243 so as to reduce the light loss. Meanwhile, the light can be received if the finger touches only the transparent handheld part 211 of the housing 21 while using the input device 20. With the light reflected by the finger, the photo plethysmographic signal can be measured. Since user's finger does not have a direct contact to the sensor module 23, the surface of the sensor module 23 thus can be kept clean so as to ensure the reliability of the measuring result.

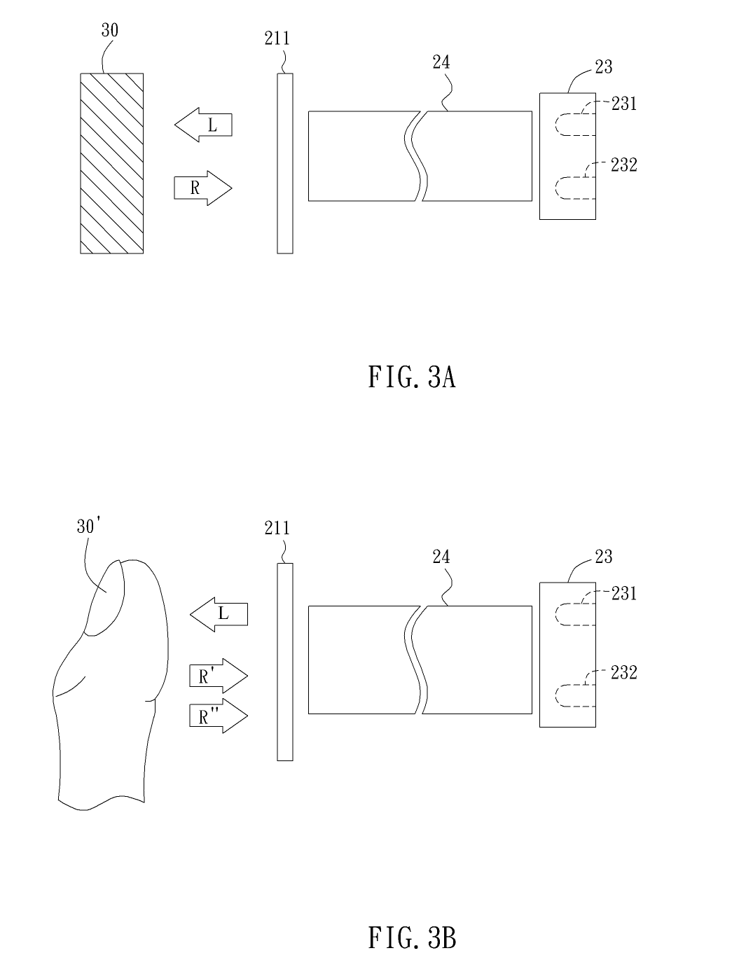

As shown in FIG. 3A, after the light emitting element 231 transmits the light L to the transparent handheld part 211 through the light guiding element 24 and the light emits out of the input device 20, the light meets a reflecting object 30 and thus a reflected light R is generated. The reflected light R is then transmitted to the sensor element 232 through the light guiding element 24 within a time unit. At this time the value difference between the light L and the reflected light R may be categorized to a DC signal or a background value.

If the finger is the object to be measured, as shown in FIG. 3B, after the light L is emitted out from the light emitting element 231 through the light guiding element 24, the light L meets the surface of the finger, which is the reflecting object 30′. Since the refractiveness and the refractive angles of the light vary by the blood volume condition in blood vessels, the different reflected lights R′ and R″ are generated. Signals, such as the reflected lights R′ and R″, received by the sensor element 232 through the light guiding element 24 within different time unit are continuous. At this time the value difference between the light L and the reflected lights R′ and R″ may be categorized to an AC signal and a measuring value. The efficacy of the physiological measuring function can be obtained instantly by deducting the described background value through the electronic component. Moreover, the user is able to get an instant physiological condition from a display (not shown).

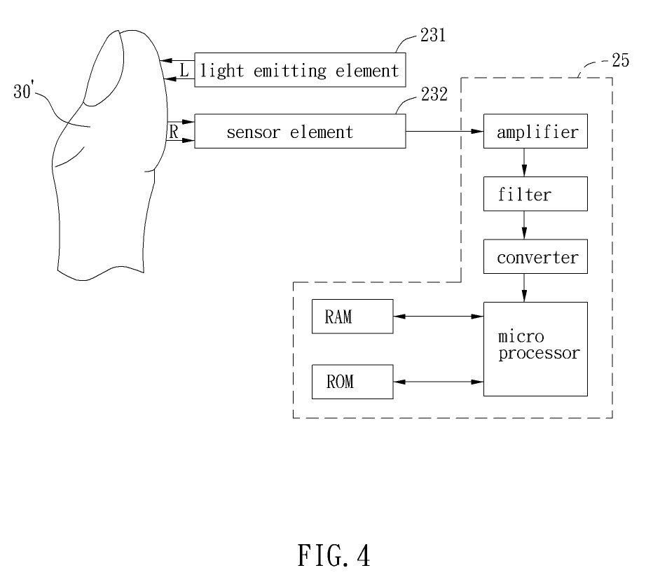

As shown in FIG. 4, the light emitting element 231 emits the light L, which is reflected by the reflecting object 30′ (finger). After that, the reflected light R is received by the sensor element 232, and the signal will be calculated by the electronic component 25. The electronic component 25 includes an amplifier, a filter, a converter, a microprocessor, a ROM, a RAM, or their combinations.

### Second Embodiment

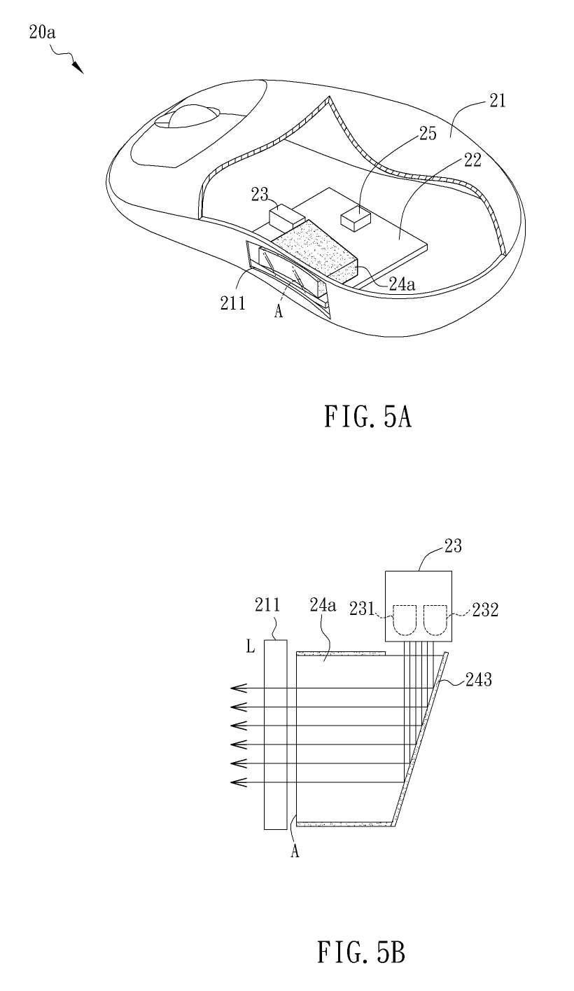

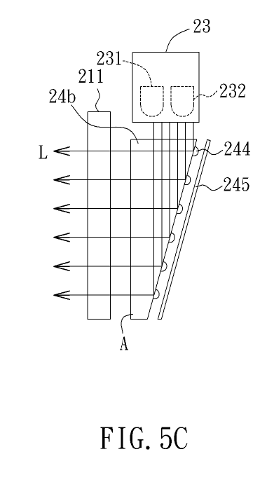

With reference to FIGS. 5A and 5B, which illustrate another preferred embodiment of the input device with physiological measuring function according to the invention. FIG. 5B is a schematic diagram of the light L emitted from the light emitting element 231 shown in FIG. 5A. The input device 20a of the embodiment includes a housing 21, a circuit board 22, a sensor module 23, and a light guiding element 24a. The light guiding element 24a is located between the sensor module 23 and the transparent handheld 211. The location of the sensor module 23 can be adjusted according to the actual need or the layout of the circuit board 22. In this embodiment, the sensor module 23 is located on a side surface of the light guiding element 24a, and the corresponding locating between the sensor module 23 and the transparent handheld part 211 is not limited. Because the housing 21, the circuit board 22, and the sensor module 23 have been described in the above embodiment, the detailed description thereof will be omitted.

The difference between the light guiding element 24a of the embodiment and the light guiding element 24 described in the above embodiment is that the light guiding element 24a is a solid light guiding element such as a rectangular light guide plate. The light guiding element 24a of the embodiment may be made of polymethyl methacrylate (PMMA) or polycarbonate (PC), which is a transparent material with the property of the total reflection. Thus the light guiding element 24a can transmit the light signal. In the embodiment, the light emitting surface A of the light guiding element 24a may be adjusted to the shape of the transparent handheld 211 so as to carry out the total reflection. After the light emitted from the light emitting element 231 enters into the light guiding element 24a, the light emits out from the light emitting surface A and reaches the transparent handheld part 211.

In order to prevent the light from scattering during the process of total reflection in the light guiding element 24a, a reflecting film 243 may be applied to the exterior of the light guiding element 24a so as to reduce the light loss and increase the light emitting efficiency of the light guiding element 24a on the light emitting surface A. To be noted, the position of the reflecting film 243 shall avoid the positions of the corresponding sensor module 23 and transparent handheld part 211 so that the light path will not be affected. Additionally, the light reflected by the finger shall be emitted back to the sensor element 232 through the same path, and the detailed description thereof will be omitted.

As shown in FIG. 5C, the aspect of another light guiding element 24b is shown. In the embodiment, the light guiding element 24b is a wedge shape light guide plate or a wedge shape light guide rod. Multiple dot structures 244 and a reflection sheet 245 may be disposed on one side of the light guiding element 24b opposite to the light emitting surface A. The dot structure 244 may be formed with screen printing so as to destroy the total reflection in the light guiding element 24b. It is adjusted to the reflection sheet 245 so that the light will again be emitted to the light guiding element 24b so as to increase the light emitting efficiency on the light emitting surface A of light guiding element 24b.

Furthermore, the dot structure 244 may be as well directly printed on the side of the reflection sheet 245 facing the light guiding element 24b. Moreover, in order to make the light L emitted out from the light emitting surface A has a more uniform light intensity, the number of the dot structures 244 may vary with the distance from the light emitting element 231. For example, fewer dot structures 244 may be disposed if the light emitting element 231 is closer; more dot structures 244 may be disposed if the light emitting element 231 is farther.

While using the input device 20a, the user holds upon the transparent handheld part 211. It is more preferred to cover the part where the transparent handheld part 211 corresponds to the light emitting surface A of the light guiding elements 24a and 24b with the finger so as to increase the reliability of measuring. The detailed description of the light reflection by the finger will be omitted.

### Third Embodiment

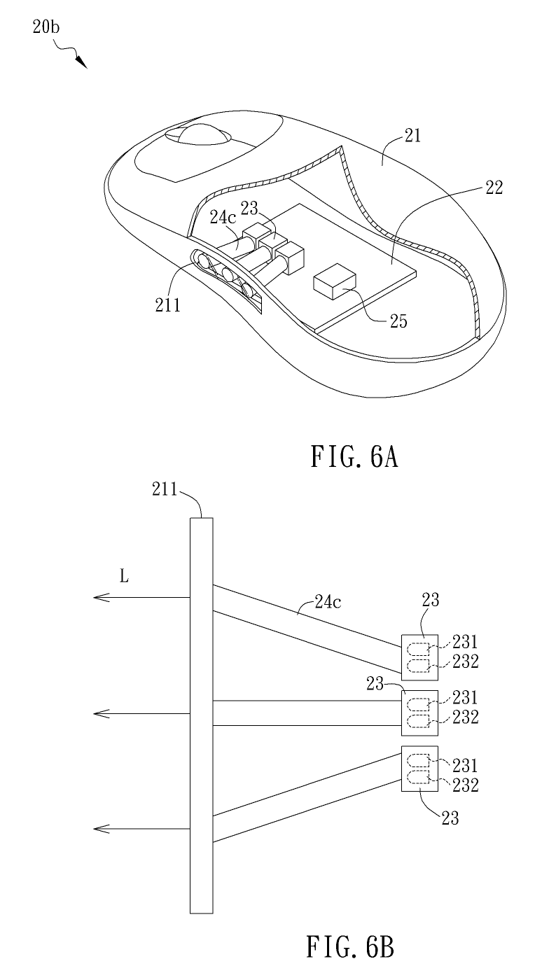

As shown in FIGS. 6A and 6B, the input device 20c in the third embodiment of the invention includes a housing 21, a circuit board 22, a sensor module 23, and a light guiding element 24c. The light guiding element 24c is located between the sensor module 23 and the transparent handheld part 211. Since the housing 21, the circuit board 22, and the sensor module 23 have been described above, the detailed description thereof will be omitted.

The difference between the light guiding element 24c of the embodiment and the light guiding elements 24 and 24a of the previous embodiments is that the light guiding element 24c includes a plurality of optical fibers. Using the optical fibers may increase the transfer rate of the light signals between the sensor module 23 and the transparent handheld part 211. One end of the optical fiber is connected to the sensor module 23 and the other end is located adjacent to the transparent handheld part 211. As a result, the light L emitted from the light emitting element 231 can be transmitted directly to the transparent handheld part 211 through the optical fiber. The reflected light R is directly transmitted to the sensor element 232 through the optical fiber as well so as to increase the light transfer rate and reduce the light loss.

Naturally, other than that the part of the light guiding element 24c corresponding to the transparent handheld part 211 and sensor module 23 needs to remain transparent. The light guiding element 24c may also be coated with a reflecting film (not shown), so that the light L would move forward in the light guiding element 24c so as to reduce the light loss and increase the light emitting efficiency of the light emitting surface A on the light guiding element 24c.

To sum up, the input device with the physiological measuring function according to the preferred embodiment of the invention may be adjusted to different physiological conditions and users' habits through the light guiding element, thereby extending the measuring area. In addition, since the sensor module does not have a direct contact with the user, the surface of the sensor module can be kept clean so as to ensure the reliability of the measuring result.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An input device with a physiological measuring function, comprising:
a housing having a transparent handheld part;
a circuit board disposed in the housing;
a sensor module electrically connected with the circuit board; and
a light guiding element located between the sensor module and the transparent handheld part.

2. The input device according to claim 1, wherein the sensor module comprises at least one light emitting element and a sensor element.

3. The input device according to claim 2, wherein the light emitting element is a light emitting diode (LED) or an organic LED.

4. The input device according to claim 2, wherein the sensor element is a photo diode (PD), a charge coupled device (CCD), or a complementary metal oxide semiconductor (CMOS).

5. The input device according to claim 1, wherein the light guiding element is a tube light guiding element, a solid light guiding element, or an optical fiber.

6. The input device according to claim 1, wherein the light guiding element comprises a reflecting film.

7. The input device according to claim 1 being a mouse.

8. The input device according to claim 1, wherein the sensor module is a photo plethysmographic (PPG) sensor module.

9. The input device according to claim 1, further comprising:
an electronic assembly comprising an amplifier, a filter, a converter, a microprocessor, a ROM, a RAM, or their combinations.
